(19) United States
(12) Patent Application Publication
(10) Pub. No.: US 2009/0142065 A1
(43) Pub. Date: Jun. 4, 2009

(54) OPTICAL DATA-BUS SYSTEM

(75) Inventor: Stefan Kreusser, Neu-Esting (DE)

Correspondence Address: DITTHAVONG MORI & STEINER, P.C., 918 Prince St., Alexandria, VA, 22314, US

(73) Assignee: Rohde & Schwarz GmbH & Co. KG, Muenchen (DE)

(21) Appl. No.: 12/295,503

(22) PCT Filed: Mar. 29, 2007
(86) PCT No.: PCT/EP2007/002848

§ 371 Date: Sep. 30, 2008

(30) Foreign Application Priority Data
Mar. 30, 2006 (DE) 10 2206 014 848.7

(51) Int. Cl. H04B 10/10

(52) U.S. Cl. 398/130

(57) ABSTRACT

An optical data-bus system for wireless signal transmission between two modules of an appliance, where the modules are each equipped with at least one transmitter and/or at least one receiver, and where the transmitter is a laser diode, and the receiver is a photo-element, with which a laser beam emitted by the laser diode is aligned. Each transmitter and/or receiver of a module is encapsulated within a metallic housing, and, in the region of the transmitter and/or of the receiver, the metallic housing provides a window made of a material, which is transparent for the laser beam. A processor, which converts electrical control signals into modulation signals, which are suitable for optical modulation, or respectively which converts optical modulation signals into electrical control signals, is provided for each module.

The present invention relates to an optical data-bus system.

A device for wireless, optical transmission of data, speech, audio and video information, which can bridge distances of more than 2.5 km even in poor weather conditions, such as fog, drizzle or rain showers, is already known from DE 197 15 636 A1. The device according to DE 197 15 636 A1 comprises at least one cylindrical transmitter module, one cylindrical receiver module, a transmitter optic, a receiver optic, a navigation aid, an aiming device displaceable in its longitudinal axis, wherein the aiming device is disposed between the transmitter optic and the receiver optic, and one or more circuit boards, one or more hybrid units and one or more adjustment devices.

The disadvantage of the device for wireless optical transmission described in DE 197 15 636 A1 is that it requires complicated adjustment in order to install a fixed optical transmission pathway. This requires adjustment devices, which comprise many mechanical parts or precision-mechanical components dependent upon the desired accuracy of the adjustment. Furthermore, once the transmission pathway has been adjusted, it is necessary to ensure by means of a locking device that it remains stable and cannot be displaced after a certain period of use. The mechanical cost for this adjustment and locking leads to increased structural complexity and/or an increased space requirement for a device for wireless optical transmission, so that a device of this kind cannot be integrated into an appliance with a modular structure. The measures for adjustment and locking known to the prior art are not suitable for integration into a further appliance because of the increased space requirement.

The object of the invention is therefore to provide a data-bus system for wireless transmission, which can be readily integrated into further appliances of modular structure without incurring additional costs for adjustment and locking.

This object is achieved by the optical data-bus system for wireless signal transmission between two modules according to claim 1.

The measures specified in the dependent claims relate to advantageous further developments of the optical-data bus according to the invention.

A laser diode is advantageously provided in the transmitter, and a photo-element, in particular, a photodiode aligned with the laser beam emitted from the laser diode, is advantageously provided in the receiver.

The optical data bus of the system according to the invention for wireless signal transmission is used respectively between two modules of an appliance, wherein the modules are each advantageously equipped with a transmitter and a receiver, thereby allowing a bidirectional connection between the modules, which are disposed opposite to one another.

The provision of a processor in each case for converting electrical control signals into modulation signals suitable for the optical modulation and respectively for converting optical modulation signals into control signals is additionally advantageous for the high-speed implementation of the respective conversion of the signals.

The laser diode is advantageously a VCSEL (Vertical Cavity Surface Emitting Laser) laser diode, which emits coherent light rays perpendicular to a defined plane, wherein the direction of the coherent light rays can be altered by a tilted or also a rotated arrangement of the VCSEL laser diode within the transmitter without additional adjustment costs in the transmitter or in the arrangement as a whole.

It is also advantageous if the wavelength of the emitted laser beam is disposed within the spectral range visible to the human eye, so that the user can ascertain through a simple visual check that the emitted laser beam irradiates the sensitive region of the photo-element arranged opposite to the transmitter.

Moreover, it is advantageous if a lens for widening the emitted laser beam is integrated within the transmitter, so that the emitted laser beam undergoes a defined divergence thereby increasing the spatial tolerance of the optical transmission pathway so that the emitted laser beam strikes the sensitive region of the photodiode even if the photodiode is not perfectly aligned relative to the transmitter.

It is additionally advantageous if a lens is integrated within the receiver for bundling the received laser beam in order to guarantee that the intensity of the received laser beam on the photo-element is sufficient for the reconstruction of the transmitted useful signal.

It is also advantageous if the spatial expansion of the wireless signal transmission occurs within a defined, preferred direction, so that the optical data bus according to the invention can be readily installed by the user.

Moreover, it is advantageous if the actual useful signal, which is, for example, an electrical control signal, is modulated on an optical signal, thereby reducing the cost in terms of electromagnetic compatibility of the high-frequency useful signal, wherein the modulated optical signal is then demodulated at the receiver end, so that the useful signal can be re-routed or further processed as an electrical signal.

It is also advantageous if the modules are each encapsulated in a preferably-metallic housing and, in the region of the transmitter and the receiver, each provide a window transparent for the laser beam, wherein the metallic housing serves as a shield from the surrounding high-frequency signal.

One further advantage of the optical data bus according to the invention is that the information exchange of digital data by means of wireless signal transmission can be implemented at a fast data rate, the data rate being, for example, at least 16 Mbit/s, which is faster than the maximum data rate possible via an infrared interface.

Moreover, the optical data bus according to the invention has the advantage of an improved electromagnetic compatibility, because the electrical connections can be kept extremely short and the component groups of the transmitter and the receiver are galvanically decoupled in one transmission direction.

The layout and structure of the modules can also be advantageously simplified as a result of the short electrical connections.

The following description and drawings refer to exemplary embodiments according to the invention of the solution to the problem presented above.

The drawings are as follows:

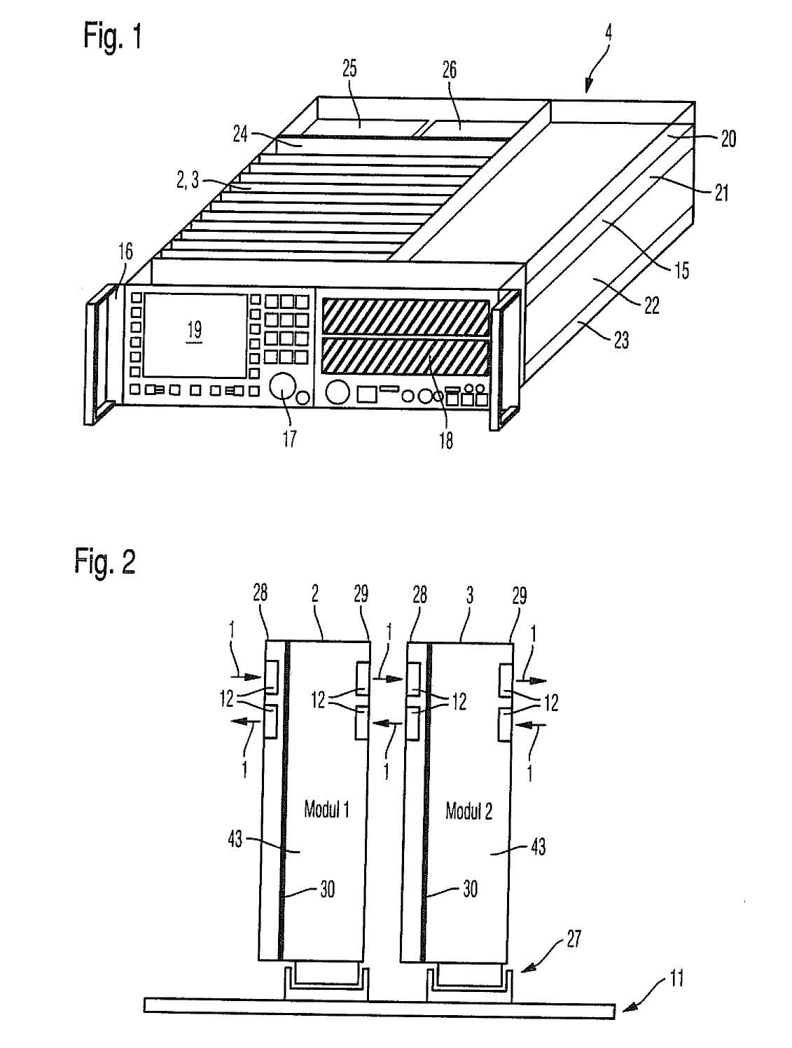

FIG. 1 shows a schematic presentation of an open radio appliance using the optical data bus according to the invention;

FIG. 2 shows a schematic presentation of two adjacent modules of the radio appliance presented in FIG. 1 including a schematic presentation of the optical data bus according to the invention; and

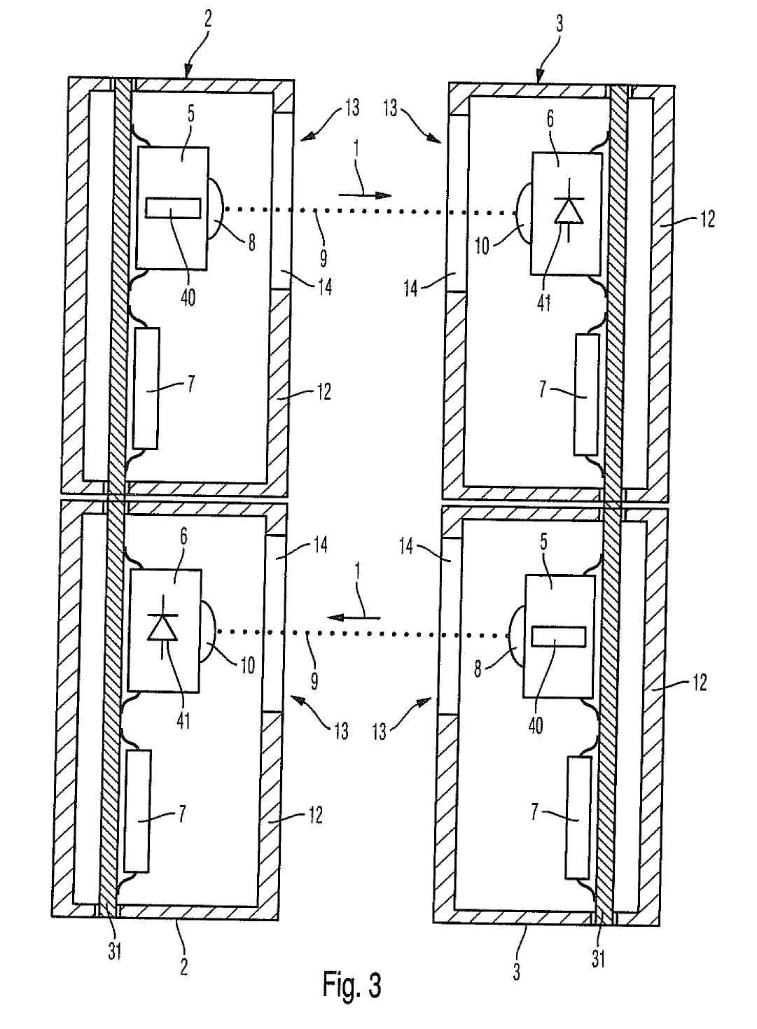

FIG. 3 shows a schematic presentation of the optical data bus according to the invention with adjacent modules.

FIG. 1 shows a schematic presentation of an open appliance 4, which, in the exemplary embodiment, is a radio appliance using the optical data bus 1 according to the invention.

The appliance 4 using the optical data bus 1 according to the invention provides a power pack 15, a motherboard 11 illustrated in FIG. 2 and a front panel 16 with an arrangement of operating elements 17, a ventilation slot 18 and a monitor 19. The power pack 15, which contains an output-stage amplifier 20 or an integrated alternating voltage source 21, a heat sink 22 with ventilation elements and a direct voltage source 23, is disposed behind the front panel 16.

The motherboard 11, on which up to eleven modules 2, 3, such as a high-frequency modules, control modules or modules for digital signal processing, can be provided, is disposed alongside the power pack 15, directly behind the front panel 16. The region for the maximum of eleven modules 2, 3 is limited by a dividing wall 24, which is attached parallel to the modules 2, 3. A region 25 for additional interface connections 26 or cables for further data buses is provided behind this dividing wall 24.

In each case, an optical data bus 1 according to the invention is provided behind two adjacent modules 2, 3. The optical data bus 1 according to the invention is used for wireless signal transmission respectively between two modules 2, 3 of the appliance 4, wherein the modules 2, 3 are each equipped with a transmitter 5 and a receiver 6 and with a processor 7 for converting electrical control signals into modulation signals suitable for optical modulation or respectively for converting optical modulation signals into electrical control signals. This is illustrated in FIG. 3.

The transmitter 5 of the optical data bus 1 according to the invention is a laser diode 40; and the receiver 6 of the optical data bus 1 according to the invention is a photo-element or respectively a photodiode 41 aligned with the laser beam 9 emitted by the laser diode, of which the spectral sensitivity includes the spectral range of the emitted laser beam 9. The laser diode 40 of the optical data bus 1 according to the invention may preferably be a VCSEL (Vertical Cavity Surface Emitting Laser) laser diode, which emits coherent light rays with a wavelength between 780 nm and 850 nm perpendicular to a plane defined within the module 2, 3 or within the laser diode 40.

A lens B for widening the laser beam 9 is integrated within the transmitter 5, so that the emitted laser beam 9 undergoes a defined divergence thereby expanding the tolerance range for the adjustment of the optical data bus 1 according to the invention.

A lens 10 for bundling the laser beam 9 is integrated within the receiver 6 of the optical data bus 1 according to the invention thereby guaranteeing a sufficient intensity of the incoming laser beam 9 in the receiver 6.

The wireless signal transmission by means of the optical data bus 1 according to the invention is bidirectional, wherein a point-to-point connection is provided in each case between two adjacent modules 2, 3, and the module 2 provides a point-to-point connection both with the module 3 adjacent on the right-hand side and also with the module adjacent on the left-hand side, which is not illustrated in greater detail. The spatial expansion of the wireless signal transmission between the two adjacent modules 2, 3 occurs within a defined preferred direction.

Before the wireless signal transmission, the high-frequency optical signal of the laser diode 40 is modulated with a useful signal. This modulated signal is then transmitted to the adjacent module 2, 3, where it is demodulated again in the receiver 6. Only the reconstructed useful signal is re-routed or respectively further processed via the processor 7 and a printed-circuit board 31 provided between the transmitter 5 and the receiver 6.

FIG. 2 shows a schematic presentation of two adjacent modules 2, 3 of the appliance 4 illustrated in FIG. 1, wherein the adjacent modules 2, 3 are electrically connected to the motherboard 11 by means of two module ports 27. Schematically-illustrated transmitters 5 and receivers 6 are provided respectively at the front side 28 and the rear side 29 of the modules 2, 3, so that a module 2, 3 can exchange data both with its right-hand neighbour and also with its left-hand neighbour via a bidirectional connection, which is provided by the optical data bus 1 according to the invention. FIG. 2 shows only the housing 12 of the transmitters 5 and respectively receivers 6.

A stable attachment of the modules 2, 3 in the appliance 4 can be realised, for example, by attaching a guide slot 30 within the lateral surface of the module housing or respectively of the metallic housing 43 of the individual module 2, 3, which, when the overall housing of the appliance 4 is closed, engages behind a sliding step, which is disposed on the internal side of a housing cover for the overall housing and is not illustrated in the present context.

FIG. 3 shows a schematic view of the optical data bus 1 according to the invention in the direction towards the adjacent modules 2, 3, wherein the modules 2, 3 are each encapsulated inside a metallic housing 12, and the metallic housing 12 provides, in the region of the transmitter 5 or respectively the receiver 6, a window 14, which is made of a material, which is transparent for the laser beam emitted by the transmitter 5. A suitable material is, for example, a transparent synthetic material such as PMMA. Leaving the aperture open would also be possible.

In this context, an information exchange of digital data is implemented with a fast data rate of, for example, at least 16 Mbit/s by means of wireless signal transmission, wherein the attainable data rate corresponds at least to the maximum-possible data rate for an optical transmission pathway with infrared radiation.

It is evident from the schematic presentation according to FIGS. 1 and 3 that the transmitter 5 of the first module 2 is only a few centimetres distant from the receiver 6 of the second module 3, so that the optical point-to-point connection is not shielded.

By contrast with a conventional information exchange with electrical signals, the optical transmission provides the following advantages. Improved electromagnetic compatibility is achieved through the galvanic decoupling of the two component groups 2 and 3 and because the electrical connections, in particular the electrical connection between the processor 7 and the optical transmitter 5 or receiver 6, can be kept very short. The layout and structure of the two component groups 2, 3 are simplified by the short electrical connections. With high-frequency signals for high-speed electrical data buses, line impedances must be accurately observed over the entire length of the line. This can be achieved only to a limited extent or with expensive ports when using electrical connections, especially in the case of plug-and-socket connections.

The invention is not restricted to the exemplary embodiment presented and, in particular, can also be used within a rack with different, intercommunicating high-frequency components, such as a mobile radio tester, in which it can form a test bus, for example, according to IEC standards.

1. Optical data-bus system for wireless signal transmission between two modules of an appliance, wherein the modules are each equipped with at least one transmitter and/or at least one receiver; and
wherein the transmitter is a laser diode, and the receiver is a photo-element, with which a laser beam emitted by the laser diode is aligned;
wherein each transmitter and/or receiver of a module is encapsulated within a metallic housing, and, in the region of the transmitter and/or of the receiver, the metallic housing provides a window made of a material, which is transparent for the laser beam;
wherein a processor, which converts electrical control signals into modulation signals, which are suitable for optical modulation, or respectively which converts optical modulation signals into electrical control signals, is provided for each module.

2. Optical data-bus system according to claim 1, wherein the photo-element is a photodiode.

3. Optical data-bus system according to claim 1, wherein the laser diode is a VCSEL (Vertical Cavity Surface Emitting Laser) laser diode.

4. Optical data-bus system according to claim 1, wherein the laser diode emits coherent light rays perpendicular to a longitudinal extension of the module.

5. Optical data-bus system according to claim 1, wherein the transmitter emits a laser beam with a wavelength, which is smaller than 850 nm but greater than 780 nm.

6. Optical data-bus system according to claim 1, wherein a lens for widening the emitted laser beam is integrated in the transmitter.

7. Optical data-bus system according to claim 1, wherein a lens for bundling the received laser beam is integrated in the receiver.

8. Optical data-bus system according to claim 1, wherein the wireless signal transmission is bidirectional.

9. Optical data-bus system according to claim 1, wherein the spatial expansion of the wireless signal transmission occurs within a preferred direction.

10. Optical data-bus system according to claim 1, characterized by a modulation of a high-frequency optical signal with a useful signal.

11. Optical data-bus system according to claim 1, characterized by a demodulation of a received, modulated, optical signal

12. Optical data-bus system according to claim 1, wherein at least two modules are arranged adjacent to one another within the appliance.

13. Optical data-bus system according to claim 12, wherein the modules are connected to one another via a motherboard.

14. Optical data-bus system according to claim 1, wherein an information exchange of digital data is implemented by means of wireless signal transmission with a fast data rate of at least 16 Mbit/s.

15. Optical data-bus system according to claim 1, wherein the transmitter of the first module is disposed at a distance of only a few centimetres from the receiver of the second module.

16. Optical data-bus system according to claim 1, wherein the appliance is a radio appliance.

17. Optical data-bus system according to claim 2, wherein the laser diode is a VCSEL (Vertical Cavity Surface Emitting Laser) laser diode.

18. Optical data-bus system according to claim 2, wherein the laser diode emits coherent light rays perpendicular to a longitudinal extension of the module.

19. Optical data-bus system according to claim 3, wherein the laser diode emits coherent light rays perpendicular to a longitudinal extension of the module.

20. Optical data-bus system according to claim 17, wherein the laser diode emits coherent light rays perpendicular to a longitudinal extension of the module.
